(19) United States
(12) Patent Application Publication
(10) Pub. No.: US 2011/0110528 A1
(43) Pub. Date: May 12, 2011

(54) HEARING DEVICE WITH SIMULATION OF A HEARING LOSS AND METHOD FOR SIMULATING A HEARING LOSS

(75) Inventor: MATTHIAS LATZEL, EGGOLSHEIM (DE)

(73) Assignee: SIEMENS MEDICAL INSTRUMENTS PTE. LTD., SINGAPORE (SG)

(21) Appl. No.: 12/943,445

(22) Filed: Nov. 10, 2010

(30) Foreign Application Priority Data
Nov. 10, 2009 (DE) 10 2009 052 574.2

(51) Int. Cl. H04R 3/02

(52) U.S. Cl. 381/73.1

(57) ABSTRACT

A hearing device has a first earpiece for emitting a first sound signal. The hearing device also includes a device for simulating the hearing loss of a hearing-impaired person. The device changes the first sound signal emitted by the first earpiece in accordance with the hearing loss. An associated method is likewise specified. The hearing device is able to simply and accurately simulate the hearing loss of a hearing-impaired hearing device wearer.

### CROSS-REFERENCE TO RELATED APPLICATION

This application claims the priority, under 35 U.S.C. §119, of German application DE 10 2009 052 574.2, filed Nov. 10, 2009; the prior application is herewith incorporated by reference in its entirety.

### BACKGROUND OF THE INVENTION

### Field of the Invention

The invention relates to a hearing device and a method for simulating a hearing loss.

Hearing devices are wearable hearing apparatuses used to assist the hard of hearing. In order to accommodate the numerous individual requirements, different configurations of hearing devices are provided, such as behind-the-ear hearing devices, hearing devices with an external earpiece and in-the-ear hearing devices, for example also concha hearing devices or canal hearing devices. The hearing devices cited by way of example are worn on the outer ear or in the auditory canal. Bone conduction hearing aids, implantable or vibrotactile hearing aids are also commercially available. With these the damaged hearing is stimulated either mechanically or electrically.

In principle hearing devices have as their essential components an input transducer, an amplifier and an output transducer. The input transducer is generally a sound earpiece, e.g. a microphone, and/or an electromagnetic earpiece, e.g. an induction coil. The output transducer is mostly realized as an electro-acoustic transducer, e.g. a miniature loudspeaker, or as an electromechanical transducer, e.g. a bone conduction earpiece. The amplifier is generally integrated in a signal processing unit. This basic structure is shown in FIG. 1 using the example of a behind-the-ear hearing device 1. A hearing device housing 2 to be worn behind the ear has built into it one or more microphones 3 for receiving the sound from the environment. A signal processing unit 4 which is also integrated in the hearing device housing 2 processes the microphone signals and amplifies them. The output signal from the signal processing unit 4 is transmitted to a loudspeaker or earpiece 5 which outputs an acoustic signal. The sound is transmitted to the hearing device wearer's eardrum by way of a sound tube which is fixed in the auditory canal by use of an otoplastic. The hearing device 1 and in particular the signal processing unit 4 are supplied with power by a battery 6 which is also integrated in the hearing device housing 2.

A demonstration of defective hearing and/or a simulation of a hearing loss may be expedient in order to indicate to a relative or care giver how the hearing-impaired person perceives his/her acoustic environment. A demonstration of this type may inter alia be used for the following situations:

to educate companions of the hearing-impaired patient during visits to ENT specialists,

to present information in order to engage public attention about the need for preventive action or to raise public awareness of hearing-impaired persons in society, or

for a visit to a hearing device acoustician, if the hearing-impaired person arrives with a companion for hearing device adjustment/information purposes, so that the companion can obtain an (acoustic) impression of what the hearing-impaired person still perceives and how.

A hearing loss simulation can however also be used in hearing device development. The testing of hearing device algorithms is an important part of each hearing device development. For this purpose, clinical studies are generally performed, during which hearing-impaired patients with or without a hearing device participate as test persons. The details of the test persons are however frequently dependent on different subjective factors, like for instance general satisfaction, attitudes towards technology in general, age, enthusiasm, available time, etc., which can significantly influence the results. It would be meaningful here to invite hearing experts who possess experience involving the assessment of acoustic signals. The results are therefore more valid and reproducible and are thus more valuable for the decision for or against a certain algorithm or a further development. Experts/test persons with normal hearing can be rendered hard-of-hearing by the simulation of a hearing loss. The assessment of the hearing device algorithms thus takes place via an expert. In addition, there is thus the possibility of the same expert being able to assess a hearing device algorithm with different hearing losses. This is advantageous in that the variance which results from the assessment of different test persons during conventional clinical test steps, can be minimized.

A simulation of a hearing loss can also be meaningful for a hearing device acoustician with normal hearing. An adjustment of hearing devices is either related to mean values or the hearing device wearer is used as a “gauge”. This “gauge” is however often very inaccurate and the adjustment is therefore either a very long-winded process or essentially ends in an incorrect adjustment, instead of an optimized adjustment. This is particularly the case with especially complicated hearing losses, like for instance low frequency loss or profound hearing loss, since the adjustment there frequently equates to a “lottery” or a “trial and error process”. In such instances, a simulation of the hearing loss can be used so that the acoustician individually adjusts the hearing device to the hearing-impaired person himself. To this end, with the aid of the simulation of the hearing loss, the acoustician experiences the perception of the hearing-impaired person, which is then to be compensated by way of the correct hearing device adjustment.

Published, non-prosecuted German patent application DE 101 10 945 A1 therefore discloses a simulation of the hearing loss of a hearing-impaired person. Firstly, the hearing ability of the hearing-impaired person is registered. Then test signals are adjusted to the thus determined hearing ability and presented to a person with normal hearing via loudspeakers. This person herewith obtains a largely realistic impression of the hearing loss of the hearing-impaired person. The arrangement of the loudspeakers and the acoustic properties of the room in which the loudspeakers are arranged nevertheless play a not inconsiderable role in the simulation.

### SUMMARY OF THE INVENTION

It is accordingly an object of the invention to provide a hearing device with simulation of a hearing loss and a method for simulating the hearing loss which overcome the above-mentioned disadvantages of the prior art methods and devices of this general type, which improve the simulation of a hearing loss.

A hearing device has a first earpiece for outputting a first sound signal and a device or apparatus for simulating a hearing loss, with the device changing the first sound signal emitted by the first earpiece in accordance with the hearing loss. The device is provided for changing, distorting or transforming the first sound signal emitted by the earpiece such that it is perceived and/or heard by a person with normal hearing as if he/she had the hearing loss of a hearing-impaired person. The hearing loss may correspond to the actually determined hearing loss of a hearing device wearer. The invention is advantageous in that hearing device experts, hearing device acousticians or companions of hearing-impaired persons have the perception of hearing-impaired persons during the assessment of hearing device algorithms and/or the hearing device adjustment.

The hearing loss to be simulated can be measured, determined or calculated.

In one development of the hearing device, the device can attenuate the first sound signal and/or distort its frequency, so that all types of hearing losses can be reproduced.

In a further embodiment, the device can be arranged in a sound tube and/or in an otoplastic. A hearing loss can be easily simulated as a result.

In a further embodiment, the device can be embodied purely mechanically or purely electrically. In other words, the attenuation and or frequency distortion of the first sound signal takes place mechanically or with electrical components.

In a further embodiment, the device can include a second signal processing unit, which changes and/or transforms the first sound signal.

Furthermore, the device can include a second microphone and a second earpiece, with the second microphone receiving the first sound signal emitted by the first earpiece and the second earpiece emitting the first sound signal changed by the second signal processing as a second sound signal. The hearing loss simulation thus takes place by use of the second signal processing unit.

The invention also claims a method for simulating a hearing loss by changing a first sound signal emitted by a hearing device in accordance with the hearing loss.

In a development of the method, the first sound signal can be emitted by a first earpiece.

In a further embodiment, the sound signal can be changed mechanically and/or electrically.

Furthermore, the first sound signal emitted by the first earpiece can be received by a second microphone and the first sound signal changed by the signal processing can be emitted by a second earpiece as a second sound signal.

Other features which are considered as characteristic for the invention are set forth in the appended claims.

Although the invention is illustrated and described herein as embodied in a hearing device with simulation of a hearing loss and a method for simulating a hearing loss, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a behind-the-ear hearing device with a sound tube and an otoplastic according to the prior art;

FIG. 2 is an illustration of a hearing device having a mechanical hearing loss simulation according to the invention; and

FIG. 3 is an illustration of a hearing device having an electrical hearing loss simulation according to the invention.

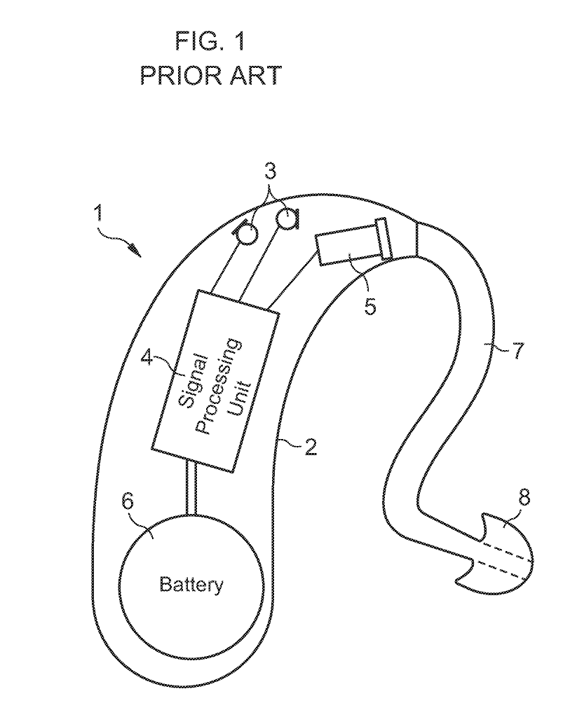

### DETAILED DESCRIPTION OF THE INVENTION

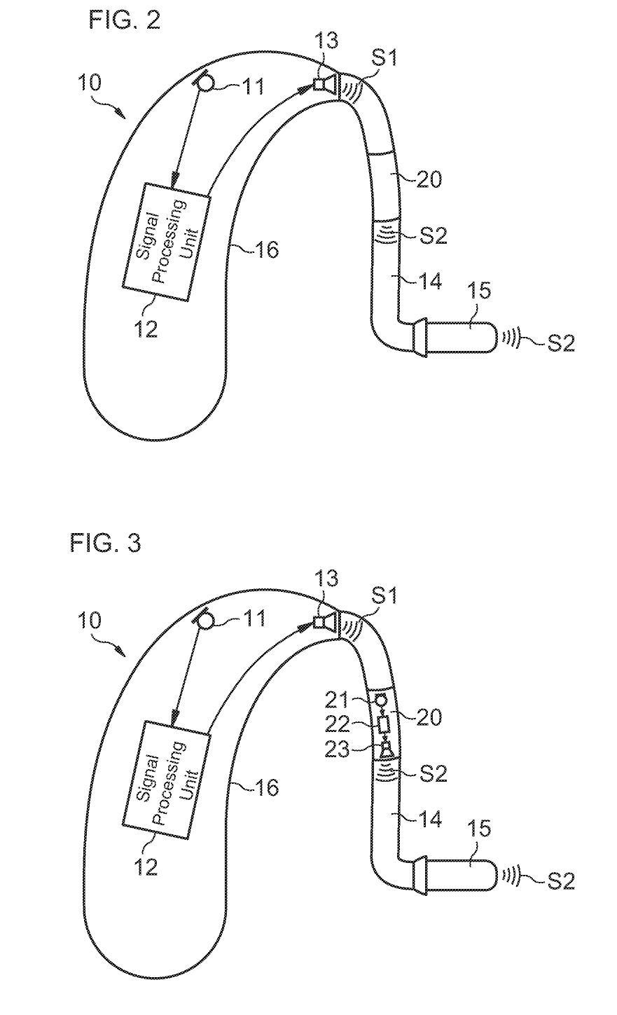

Referring now to the figures of the drawing in detail and first, particularly, to FIG. 2 thereof, there is shown a behind-the-ear hearing device 10 with a hearing device housing 16. A sound tube 14 is connected with one end to the hearing device housing 16. An otoplastic 15 rests on its other end. A first microphone 11 in the hearing device housing 16 receives ambient sound and converts the sound into an electrical signal. This is changed in a first signal processing unit 12 in the hearing device housing 16 and amplified and is emitted to a first earpiece 13 in the hearing device housing 16. The first earpiece 13 converts the thus amplified electrical signal into a first sound signal 51 and emits this into a sound tube 14.

A device or apparatus 20 for simulating the hearing loss of the hearing-impaired person is arranged in the sound tube 14 in order to impart a hearing impression, which a hearing-impaired person has when wearing the hearing device 10, to a person with normal hearing when wearing the hearing device 10. The device 20 attenuates the first sound signal 51 in a wideband or frequency-dependent fashion in accordance with the hearing loss of the hearing-impaired person. The device 20 is constructed mechanically and includes a plastic plug for instance. After the device 20, a second sound signal S2 is thus emitted, which escapes from the otoplastic 15. The second sound signal S2 thus results from the first sound signal 51 of the first earpiece 13 attenuated by the loss of sensitivity caused by the mechanical attenuation of the device 20. A person with normal hearing would then perceive the second sound signal S2 like a hearing-impaired person with a wideband or frequency-dependent loss of sensitivity.

FIG. 3 shows a behind-the-ear hearing device 10 with the hearing device housing 16. The sound tube 14 is connected with one end to the hearing device housing 16. The otoplastic 15 rests on its other end. The first earpiece 13 emits a first sound signal S1 received by the first microphone through the sound tube 14 and changed and amplified by a first signal processing unit 12 into the sound tube 14.

The device 20 for simulating the hearing loss of the hearing-impaired person is arranged in the sound tube 14 in order to impart a hearing impression, which a hearing-impaired person has when wearing the hearing device 10, to a person with normal hearing when wearing the hearing device 10. The device 20 attenuates the first sound signal in a wideband or frequency-dependent fashion in accordance with the hearing ability of the hearing-impaired person. The device 20 includes a second microphone 21, which receives the first sound signal S1, a second signal processing unit 22, which changes the first sound signal S1 in accordance with the hearing loss of the hearing-impaired person to be simulated, and a second earpiece 23, which emits the thus changed signal as a second sound signal S2 into the sound tube 14. The second signal processing unit 22 is able to simulate all types of hearing losses with the aid of a very wide variety of parameters.

The device 20 can alternatively also be arranged in the otoplastic 15.

With an inventive hearing device 20 according to FIG. 2 or 3, an expert with normal hearing, who is to assess a hearing device algorithm for instance, puts this to the test in everyday life, with his/her perception corresponding to that of a hearing-impaired person, whose hearing loss is simulated by the device 20. It is advantageous that an expert with normal hearing is able to test the hearing devices like a hearing-impaired person in everyday life and is able to assess their perception.

Furthermore, a hearing device acoustician can identify with his hearing-impaired customer the hearing situation which the latter would like to improve using his hearing device. The option is now available to the hearing device acoustician to experience the world with the ears of his/her customers and/or with their hearing loss and to adjust the hearing device 10 such that an optimal perception can be achieved by the hearing device acoustician and not via a “layman” (in other words the hearing device wearer). The adjustment therefore takes place in an essentially quicker and more targeted fashion on account of the specialist knowledge and experience of the acoustician. This may bring additional advantages during the adjustment of the hearing device from an audiological perspective, since this is often disregarded for reasons of spontaneous acceptance. In such a case, the hearing device acoustician would adjust the hearing device to the simulated hearing loss for instance such that maximum speech intelligibility is achieved. This is a setting which the hearing device wearer would very frequently dismiss, perceiving it as being too sharp.

The illustrated adjustment by the acoustician offers further advantages, the acoustician moving in the acoustic environment of his/her customer, particularly in respect of new hearing device algorithms. Their adjustment is sometimes difficult because the basic knowledge may in particular still not be available with the acousticians since such algorithms have not yet become available at the time of their configuration.

One example of such an algorithm is the so-called frequency compression or transformation. With this algorithm, frequency components are transformed into frequency ranges, in which a hearing perception can still be ensured. This adjustment requires particular accuracy, since an incorrect adjustment of the hearing device would mean an incorrect “reprogramming” of the brain of the hearing device wearer. This “reprogramming” is namely needed since the hearing-impaired person, who uses such a frequency compression, learns to hear and understand with the new frequency information.

If the adjustment is however incorrect, the hearing-impaired person leans to interpret the information of an incorrect adjustment. This is a process which is frequently irreversible. The adjustment of such hearing devices currently still takes place in accordance with rather rudimentary approaches. The inventive hearing loss simulation helps here, since the hearing device acoustician themselves perceive both the advantages and also the disadvantages of the algorithm and can thus find an optimal adjustment more easily. To this end, the hearing device acoustician does not need to know and understand all the details of the algorithm.

1. A hearing device for simulating a hearing loss of a hearing-impaired person, the hearing device comprising:
a first earpiece for emitting a first sound signal; and
an apparatus for simulating the hearing loss for a person with normal hearing, said apparatus changing the first sound signal emitted by said first earpiece in accordance with the hearing loss such that a changed first sound signal is perceived by the person with normal hearing as if he/she had the hearing loss of the hearing-impaired person.

2. The hearing device according to claim 1, wherein said apparatus at least one of attenuates the first sound signal or distort a frequency of the first sound signal.

3. The hearing device according to claim 1, further comprising a sound tube, said apparatus is disposed in said sound tube.

4. The hearing device according to claim 1, further comprising an otoplastic, said apparatus is disposed in said otoplastic.

5. The hearing device according to claim 1, wherein said apparatus is a mechanical device.

6. The hearing device according to claim 1, wherein said apparatus is an electrical device.

7. The hearing device according to claim 6, wherein said apparatus has a signal processing unit for changing the first sound signal.

8. The hearing device according to claim 7, wherein:
said apparatus has a microphone; and
said apparatus has a second earpiece, said second microphone receiving the first sound signal emitted by said first earpiece and said second earpiece emitting the changed first sound signal changed by said signal processing unit as a second sound signal.

9. A method for simulating a hearing loss of a hearing-impaired person, which comprises the step of:
changing a first sound signal, emitted by a hearing device, in accordance with the hearing loss such that a changed first sound signal is perceived by a person with normal hearing as if he/she had the hearing loss of the hearing-impaired person.

10. The method according to claim 9, which further comprises emitting the first sound signal by a first earpiece of the hearing device.

11. The method according to claim 9, which further comprises changing the first sound signal mechanically.

12. The method according to claim 9, which further comprises changing the first sound signal electrically.

13. The method according to claim 12, wherein the first sound signal emitted by the first earpiece is received by a microphone and that the changed first sound signal changed by signal processing is emitted by a second earpiece as a second sound signal.
